(19) United States
(12) Patent Application Publication
(10) Pub. No.: US 2016/0165126 A1
(43) Pub. Date: Jun. 9, 2016

(54) IMAGE PROCESSING DEVICE, IMAGING DEVICE, IMAGE PROCESSING METHOD, AND COMPUTER PROGRAM PRODUCT

(71) Applicant: KABUSHIKI KAISHA TOSHIBA, Tokyo (JP)

(72) Inventors: Nao MISHIMA, Tokyo (JP); Takuma YAMAMOTO, Yokohama (JP); Nobuyuki MATSUMOTO, Tokyo (JP)

(21) Appl. No.: 14/950,445

(22) Filed: Nov. 24, 2015

(30) Foreign Application Priority Data
Dec. 9, 2014 (JP) 2014-249134

(51) Int. Cl. H04N 5/232; G06T 5/20; G06T 7/00; G06T 5/00

(52) U.S. Cl. CPC H04N 5/23212; G06T 5/003; G06T 5/20; G06T 7/0051

(57) ABSTRACT

According to an embodiment, an image processing device includes a processing circuit configured to implement a first acquirer, a second acquirer, a first calculator, and a second calculator. The first acquirer acquires an all-in-focus image. The second acquirer acquires a first captured image taken at a first focus distance. The first calculator calculates, with respect to a pixel included in the first captured image, a first blur circle radius using the all-in-focus image and the first captured image. The second calculator calculates a first depth representing a distance to an object included in at least one of the first captured image and the all-in-focus image using the first blur circle radius.

### CROSS-REFERENCE TO RELATED APPLICATIONS

This application is based upon and claims the benefit of priority from Japanese Patent Application No. 2014-249134, filed on Dec. 9, 2014; the entire contents of which are incorporated herein by reference.

### FIELD

Embodiments described herein relate generally to an image processing device, an imaging device, an image processing method, and a computer program product.

### BACKGROUND

In recent years, a technology is known in which captured images having different focus distances (i.e., defocused images) are processed and depth estimation within the screen is performed. For example, a method is known in which depth estimation is performed using two defocused images.

In the conventional technology, the depth is estimated from the relative blurring of two defocused images. Hence, it is possible to estimate the depth corresponding to the region between the respective focus distances. However, it is difficult to estimate the depth corresponding to the remaining region.

### BRIEF DESCRIPTION OF THE DRAWINGS

FIG. 1 is a diagram illustrating an example of a system according to a first embodiment;

FIG. 2 is a diagram illustrating an image processing device according to the first embodiment;

FIG. 3 is a schematic diagram for explaining about a focus distance that is set to a first value according to the first embodiment;

FIG. 4 is a schematic diagram for explaining about the focus distance that is set to a second value according to the first embodiment;

FIG. 5 is a schematic diagram for explaining about the depth according to the first embodiment;

FIG. 6 is a diagram illustrating the relationship between the distance from a lens and a first blur circle radius according to the first embodiment;

FIG. 7 is a diagram illustrating the relationship between the distance from the lens and types of the blur circle radius according to the embodiment;

FIG. 8 is a diagram illustrating the relationship between the distance from the lens and types of the blur circle radius according to the embodiment;

FIG. 9 is a diagram illustrating an exemplary hardware configuration of the image processing device according to the first embodiment;

FIG. 10 is a diagram for explaining about a comparison example;

FIG. 11 is a diagram for explaining about a comparison example;

FIG. 12 is a diagram for explaining about the premise of a second embodiment;

FIG. 13 is a diagram illustrating an image processing device according to the second embodiment;

FIG. 14 is a diagram illustrating an exemplary reference line according to the second embodiment;

FIG. 15 is a diagram illustrating the relationship between the distance from the lens and the first blur circle radius according to the second embodiment;

FIG. 16 is a diagram illustrating an exemplary orientation of an imaging device that differs from the premise of the second embodiment;

FIG. 17 is a diagram illustrating the relationship between the distance from the lens and the first blur circle radius according to a third embodiment;

FIG. 18 is a schematic diagram illustrating a point spread function (PSF) according to the third embodiment; and

FIG. 19 is a diagram illustrating an exemplary hardware configuration of the imaging device according to a modification example.

### DETAILED DESCRIPTION

According to an embodiment, an image processing device includes a processing circuit configured to implement a first acquirer, a second acquirer, a first calculator, and a second calculator. The first acquirer acquires an all-in-focus image. The second acquirer acquires a first captured image taken at a first focus distance. The first calculator calculates, with respect to a pixel included in the first captured image, a first blur circle radius using the all-in-focus image and the first captured image. The second calculator calculates a first depth representing a distance to an object included in at least one of the first captured image and the all-in-focus image using the first blur circle radius.

Embodiments of an image processing device, an imaging device, an image processing method, and a computer program product are described below in detail with reference to the accompanying drawings.

### First Embodiment

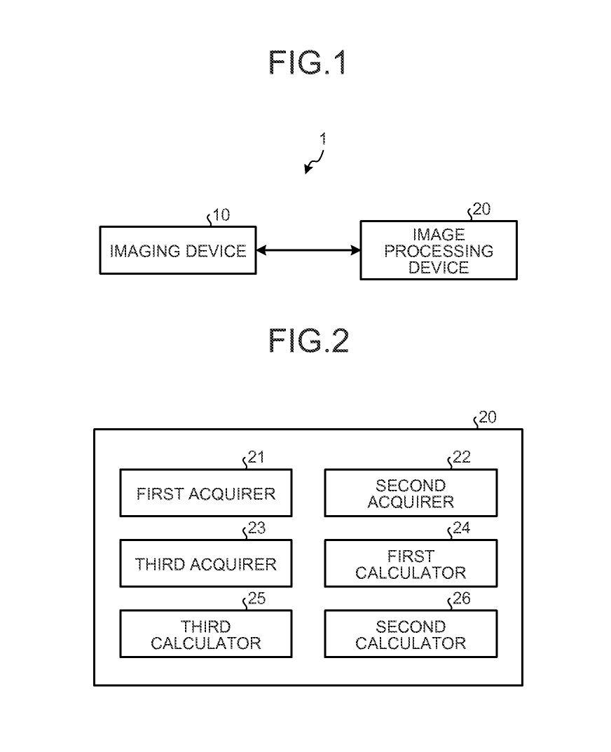

FIG. 1 is a diagram illustrating a system 1 according to a first embodiment. As illustrated in FIG. 1, the system 1 includes an imaging device 10 and an image processing device 20 that are connected to each other in a communicable manner. Herein, the connection topology between the imaging device 10 and the image processing device 20 is arbitrary. That is, the connection can either be a wired connection or be a wireless connection.

FIG. 2 is a diagram illustrating the image processing device 20. As illustrated in FIG. 2, the image processing device 20 includes a first acquirer 21, a second acquirer 22, a third acquirer 23, a first calculator 24, a third calculator 25, and a second calculator 26.

The first acquirer 21 acquires an all-in-focus image. In the first embodiment, the first acquirer 21 requests the imaging device 10 for an all-in-focus image, and acquires, in response thereto, an all-in-focus image generated by the imaging device 10. As the method for generating an all-in-focus image in the imaging device 10, it is possible to implement various known technologies. Moreover, a detailed example of the method for generating an all-in-focus image is explained later in a first modification example.

The second acquirer 22 acquires a first captured image taken at the focus distance that is set to a first value. Regarding the “focus distance”, the explanation is as follows. The imaging device 10 includes an image sensor and an optical system. When an object (a photographic subject) is present at a position separated by a predetermined distance from the optical system on the opposite side of the image sensor, the “focus distance” represents the distance between the optical system and the image sensor that is disposed such that a group of light beams coming from the object (more particularly, a plurality of light beams that spread from a single point of the object and travel ahead) pass through the optical system and then converges on the image sensor. Meanwhile, in the first embodiment, the second acquirer 22 requests the imaging device 10 for a first captured image, and acquires, in response thereto, a first captured image generated by the imaging device 10. Meanwhile, in this written description, “imaging” implies conversion of an image of a photographic subject, which is formed using an optical system such as a lens, into electrical signals.

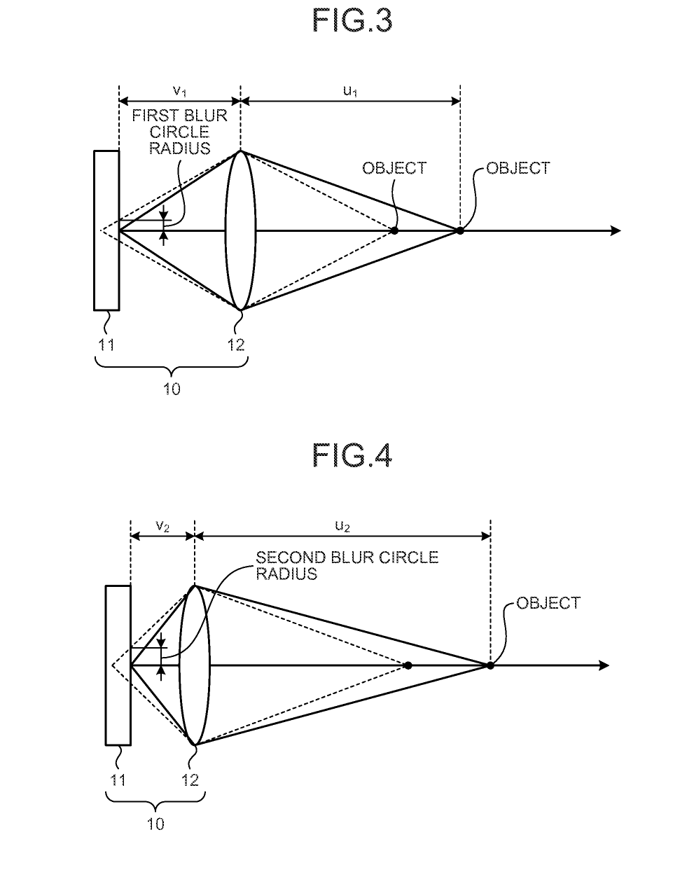

FIG. 3 is a schematic diagram for explaining about the focus distance that is set to the first value (in this example, referred to as “v₁”). With reference to FIG. 3, the imaging device 10 includes an image sensor 11. Although not illustrated in detail in FIG. 3, the image sensor 11 includes an element array having an arrangement of a plurality of photoelectric conversion elements each corresponding to a pixel (representing the smallest unit of display); a microlens array in which a plurality of microlenses is arranged on a one-to-one basis with the photoelectric conversion elements; and a color filter. As the image sensor 11, it is possible to adopt various known configurations. Meanwhile, with reference to FIG. 3, the imaging device 10 also includes a lens 12 functioning as the optical system.

In the example illustrated in FIG. 3, the image sensor 11 is disposed such that, when an object is present at the position separated by a predetermined distance u₁ from the lens 12 on the opposite side of the image sensor 11, the group of light beams coming from the object passes through the lens 12 and then converges on the image sensor 11. In the example illustrated in FIG. 3, at that time, the focus distance, which represents the distance between the image sensor 11 and the lens 12, is set to v₁. Meanwhile, if u represents the distance from the lens 12 to the object, if v represents the focus distance, and if f represents the focal length that is a unique value (fixed value) of the lens 12; then a relational expression 1/f=1/v+1/u is established. As can be understood from the relational expression, the greater the distance u from the lens 12 to the object, the smaller becomes the focus distance v. On the other hand, the smaller the distance u from the lens 12 to the object, the greater becomes the focus distance v.

In the example illustrated in FIG. 3, when the distance between the lens 12 and the object is different than the distance u₁, the group of light beams coming from the object does not converge on the image sensor 11 after passing through the lens 12. When the group of light beams, which is expected to converge at a single point, spreads on the image sensor 11, it leads to the formation of a circle. In this example, the radius of that circle is called a “blur circle radius”. In the following explanation, in the case in which the focus distance is set to the first value (v₁), the blur circle radius is sometimes called a “first blur circle radius”. For example, when the distance between the object and the lens 12 is smaller than the distance u₁, the focus distance becomes greater than the first value v₁ as can be understood from the relational expression given earlier. Hence, the distance from the lens 12 to the point at which the group of light beams coming from the object (i.e., the group of light beams expected to converge at a single point) converges after passing through the lens 12 becomes greater than the first value v₁. As a result, the group of light beams expected to converge at a single point spreads in a circular pattern on the image sensor 11. The degree of such spread is represented by the first blur circle radius.

Returning to the explanation with reference to FIG. 2, the third acquirer 23 acquires a second captured image taken at the focus distance that is set to a second value different from the first value. In the first embodiment, the second acquirer 22 requests the imaging device 10 for a second captured image, and acquires, in response thereto, a second captured image generated by the imaging device 10.

FIG. 4 is a schematic diagram for explaining about the focus distance that is set to the second value (in this example, referred to as “v₂”). In the example illustrated in FIG. 4, the image sensor 11 is disposed such that, when an object is present at the position separated by a predetermined distance u₂ from the lens 12 on the opposite side of the image sensor 11, the group of light beams coming from the object passes through the lens 12 and then converges on the image sensor 11. In the example illustrated in FIG. 4, at that time, the focus distance, which represents the distance between the image sensor 11 and the lens 12, is set to v₂. In the example illustrated in FIG. 4, if the object is present at a position separated by the distance u₂ from the lens 12, then the group of light beams coming from the object converges on the image sensor 11 after passing through the lens 12. However, when the distance between the lens 12 and the object is different than the distance u₂, the group of light beams coming from the object does not converge on the image sensor 11 after passing through the lens 12. In the following explanation, in the case in which the focus distance is set to the second value (v₂), the blur circle radius is sometimes called a “second blur circle radius”. For example, when the distance between the object and the lens 12 is smaller than the distance u₂, the focus distance becomes greater than the second value v₂ as can be understood from the relational expression given earlier. Hence, the distance from the lens 12 to the point at which the group of light beams coming from the object (i.e., the group of light beams expected to converge at a single point) converges after passing through the lens 12 becomes greater than the second value v₂. As a result, the group of light beams expected to converge at a single point spreads in a circular pattern on the image sensor 11. The degree of such spread is represented by the second blur circle radius.

Returning to the explanation with reference to FIG. 2, the first calculator 24 uses the all-in-focus image and the first captured image, and calculates, with respect to the pixels included in the first captured image, the first blur circle radius that represents the degree of circular spread of the group of light beams, which is expected to converge, on the image sensor 11. More particularly, the first calculator 24 estimates the extent of blurring to which the all-in-focus image needs to be blurred to approximate the first captured image, and calculates the first blur circle radius. Moreover, the first calculator 24 calculates the first blur circle radius such that an error between the first captured image and an image acquired by applying a Gaussian filter to the all-in-focus image for the purpose of performing smoothing with the use of a weight corresponding to the first blur circle radius is minimized. Meanwhile, in the first embodiment, the first calculator 24 calculates the first blur circle radius for each of a plurality of pixels included in the first captured image. However, that is not the only possible case. Alternatively, for example, the first calculator 24 can calculate the first blur circle radius for a particular portion of the first captured image (for example, it is possible to acquire the average of first blur circle radii of the pixels included in that portion). Still alternatively, the first calculator 24 can calculate the first blur circle radius for only a single pixel included in the first captured image.

Given below is the explanation of a method of calculating the first blur circle radius for each of a plurality of pixels included in the first captured image. Herein, the explanation is given for an example in which the first captured image, the second captured image, and the all-in-focus image have the same scale (size); and a coordinate system is implemented that has the top left coordinate of each image as the origin; that has positions in the vertical direction as the y-coordinates; and that has positions in the horizontal direction as the x-coordinates. In this example, the pixels included in the first captured image have a one-to-one correspondence with the pixels included in the second captured image as well as with the pixels included in the all-in-focus image. In the following explanation, of the pixels included in the all-in-focus image, a pixel at arbitrary coordinates (x, y) is written as I_{AIF}(x, y). Moreover, of the pixels included in the first captured image, a pixel at arbitrary coordinates (x, y) is written as I(x, y, v₁). Furthermore, for the pixel I(x, y, v₁) positioned at arbitrary coordinates (x, y), the first blur circle radius is written as b(x, y, v₁). In that case, the first blur circle radius b(x, y, v₁) for each pixel included in the first captured image represents the solution of an optimization problem given below in Equation (1).

$$b ( {v}_{1} ) = arg {min}_{b} {\sum }_{x , y} \{ {λ}_{1} ( {( I ( x , y , {v}_{1} ) - G ( b ( x , y , {v}_{1} ) ) * {I}_{AIF} )}^{2} ) + {λ}_{2} {‖ ∇ b ( x , y , {v}_{2} ) ‖}^{2} \} \qquad ( 1 )$$

In Equation (1), b(v₁) represents the set of a plurality of first blur circle radii corresponding on a one-to-one basis to a plurality of pixels included in a first captured image, and

$$arg {min}_{b} E$$

represents an operation for searching for “b” that minimizes “E”.

In Equation (1), G(b(x, y, v₁))*I_{AIF} represents that a Gaussian filter, which is used to perform smoothing using the weight (standard deviation) corresponding to the first blur circle radius b(x, y, v₁), is applied to the all-in-focus image (I_{AIF}). Moreover, in Equation (1), ∥∇b(x, y, v₁)∥² represents a term for evaluating the smoothness of the first blur circle radius between neighboring pixels (the estimated first blur circle radius), and is used to deal with the noise in the image. Furthermore, in Equation (1), λ1 (≧0) and λ2 (≧0) represent weight constants. Thus, solving the optimization problem given in Equation (1) implies estimating the extent of blurring to which the all-in-focus image needs to be blurred to approximate the first captured image. Meanwhile, in Equation (1), although the squared norm (L2) is used, that is not the only possible case. Alternatively, for example, it is also possible to use the L1 norm. Moreover, the solution of the optimization problem can be acquired by implementing the steepest descent method or the conjugate gradient method.

As a result of solving the optimization problem given in Equation (1), the first calculator 24 can calculate (estimate) the first blur circle radius b(x, y, v₁) for each pixel I(x, y, v₁) included in the first captured image.

Returning to the explanation with reference to FIG. 2, the third calculator 25 uses all-in-focus image and the second captured image, and calculates, with respect to the pixels included in the second captured image, the second blur circle radius that represents the degree of circular spread of the group of light beams, which is expected to converge, on the image sensor 11. More particularly, the third calculator 25 estimates the extent of blurring to which the all-in-focus image needs to be blurred to approximate the second captured image, and calculates the second blur circle radius. Moreover, the third calculator 25 calculates the second blur circle radius such that an error between the second captured image and an image formed by applying a Gaussian filter to the all-in-focus image for the purpose of performing smoothing with the use of a weight corresponding to the second blur circle radius is minimized. Meanwhile, in the first embodiment, the third calculator 25 calculates the second blur circle radius for each of a plurality of pixels included in the second captured image. However, that is not the only possible case. Alternatively, for example, the third calculator 25 can calculate the second blur circle radius for a particular portion of the second captured image, or can calculate the second blur circle radius for only a single pixel included in the second captured image.

Given below is the explanation of a method of calculating the second blur circle radius for each of a plurality of pixels I included in the second captured image. In the following explanation, of the pixels included in the second captured image, a pixel at arbitrary coordinates (x, y) is written as I(x, y, v₂). Moreover, for the pixel I(x, y, v₂) positioned at arbitrary coordinates (x, y), the second blur circle radius is written as b(x, y, v₂). In that case, the second blur circle radius b(x, y, v₂) for each pixel I included in the second captured image represents the solution of an optimization problem given below in Equation (2). In an identical manner to the method of calculating the first blur circle radius b(x, y, v₁), the third calculator 25 solves the optimization problem given in Equation (2) and calculates the second blur circle radius (x, y, v₂) for each pixel I(x, y, v₂) included in the second captured image.

$$b ( {v}_{2} ) = arg {min}_{b} {\sum }_{x , y} \{ {λ}_{1} ( {( I ( x , y , {v}_{2} ) - G ( b ( x , y , {v}_{2} ) ) * {I}_{AIF} )}^{2} ) + {λ}_{2} {‖ ∇ b ( x , y , {v}_{2} ) ‖}^{2} \} \qquad ( 2 )$$

In Equation (2), b(v₂) represents the set of a plurality of second blur circle radii corresponding on a one-to-one basis to a plurality of pixels included in a second captured image, and

$$arg {min}_{b} E$$

represents an operation for searching for “b” that minimizes “E”.

Returning to the explanation with reference to FIG. 2, the second calculator 26 uses each first blur circle radius and calculates the depth representing the distance between the optical system used in imaging (in this example, the lens 12) and the point at which the group of light beams coming from the object converges after passing through the optical system. In this example, although the second calculator 26 calculates the depth for each pixel included in the first captured image, it is not the only possible case. Alternatively, for example, the second calculator 26 can calculate the depth for a particular portion of the first captured image, or can calculate the depth for only a single pixel included in the first captured image. FIG. 5 is a schematic diagram for explaining about the depth. In the example illustrated in FIG. 5, from an object present at the position separated by a predetermined distance u_{d} from the lens 12 on the opposite side of the image sensor 11, a group of light beams comes out and passes through the lens 12 before converging at a point that is separated from the image sensor 11 by a distance v_{d}. Herein, the distance v_{d} is equivalent to the depth. If f represents the focal length of the lens 12; then a relational expression 1/f=1/v_{d}+1/u_{d} is established among the focal length f, the predetermined distance u_{d}, and the depth v_{d}. For example, if the distance between the lens 12 and the point at which a plurality of light beams spreading out from an arbitrary single point of the object, which is separated from the lens 12 by the predetermined distance u_{d}, again converges after passing through the lens 12 is equal to the first value (v₁); then the pixel from among the pixels included in the first captured image that corresponds to the arbitrary single point of the object (i.e., the pixel corresponding to the point at which a plurality of light beams spreading out from an arbitrary single point of the object again converges on the image sensor 11 after passing through the lens 12) has the first blur circle radius equal to a value indicating that the group of light beams has converged on the image sensor 11 (although the value is ideally equal to zero, that is not the only possible case). In the following explanation, regarding the pixel I(x, y, v₁) included in the first captured image, the corresponding depth is written as v_{d}(x, y).

Herein, the absolute value of the difference between the focus difference v₁ and the depth v_{d}(x, y) is proportional to the first blur circle radius b(x, y, v₁). Hence, between the first blur circle radius b(x, y, v₁) and the depth v_{d}(x, y), a relationship given below in Equation (3) is established.

$$b ( x , y , {v}_{1} ) = \frac{a}{{v}_{1}} \vert {v}_{1} - {v}_{d} ( x , y ) \vert \\ a = \frac{f}{{f}_{num}} \\ f \text{:} focal length \\ {f}_{num} \text{:} f value \qquad ( 3 )$$

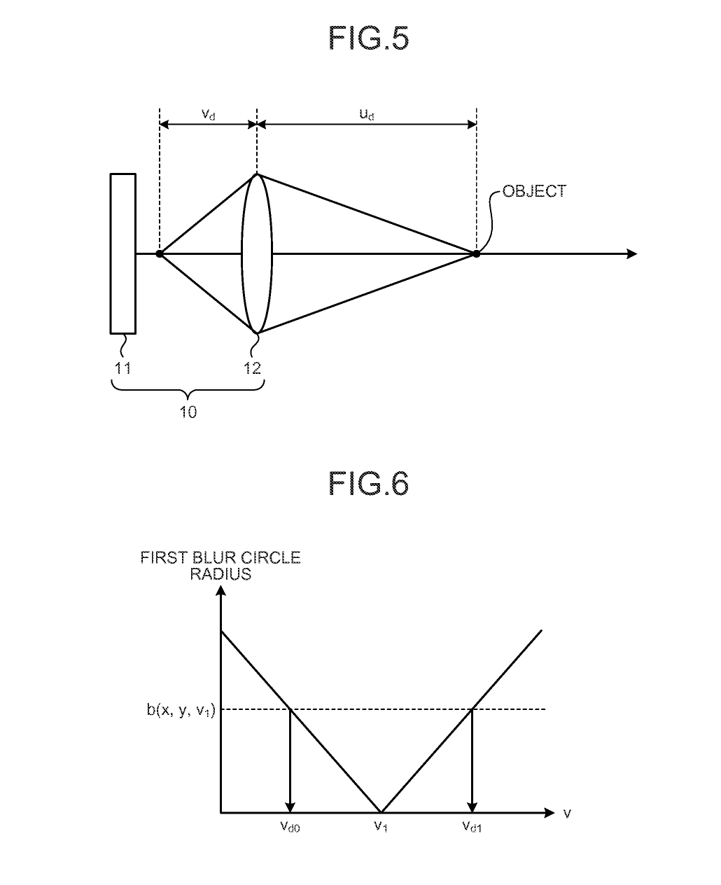

As a result of solving Equation (3), the depth v_{d}(x, y) can be expressed as given below in Equation (4). However, it is not possible to determine whether the first blur circle radius b(x, y, v₁) has the plus sign or the minus sign. FIG. 6 is a diagram illustrating the relationship between the distance v from the lens 12 in the direction toward the image sensor 11 and the absolute value of the first blur circle radius (x, y, v₁). As can be understood from FIG. 6, as the depth v_{d}(x, y) corresponding to a particular first blur circle radius (x, y, v₁), it is possible to calculate a depth v_{d1}(x, y) greater than the focus distance v₁ and a depth v_{d0}(x, Y) smaller than the focus distance v₁. However, using only the relationship given in Equation (6), it is not possible to determine which of the depths v_{d0}(x, y) and v_{d1}(x, y) is the correct depth.

$${v}_{d} ( x , y ) = \frac{a \pm b ( x , y , {v}_{1} )}{a} {v}_{1} \qquad ( 4 )$$

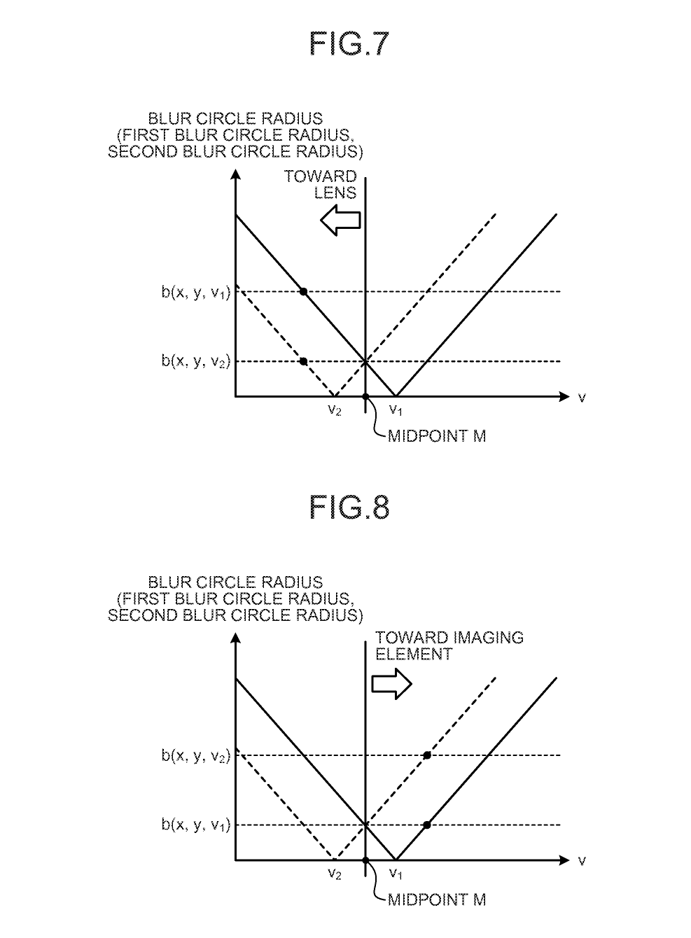

In the first embodiment, the second calculator 26 calculates the depth v_{d}(x, y) using the first blur circle radius b(x, y, v₁) and the second blur circle radius b(x, y, v₂). More particularly, when the focus distance v₁ (the first value) is greater than the focus distance v₂ (the second value), and when the first blur circle radius b(x, y, v₁) is greater than the second blur circle radius b(x, y, v₂); the second calculator 26 calculates the depth v_{d}(x, y) that represents a value positioned toward the lens 12 with respect to the midpoint between the position separated from the lens 12 toward the image sensor 11 by the focus distance v₁ and the position separated from the lens 12 toward the image sensor 11 by the focus distance v₂. FIG. 7 is a diagram illustrating the relationship between the distance v from the lens 12 in the direction toward the image sensor 11 and the absolute value of the first blur circle radius (x, y, v₁), as well as illustrating the relationship between the distance v and the absolute value of the second blur circle radius (x, y, v₂). As can be understood from FIG. 7, when the focus distance v₁ is greater than the focus distance v₂, and when the absolute value of the first blur circle radius (x, y, v₁) is greater than the absolute value of the second blur circle radius (x, y, v₂); the depth v_{d}(x, y) corresponding to the first blur circle radius (x, y, v₁) represents a value positioned toward the lens 12 with respect to the midpoint between the position separated from the lens 12 toward the image sensor 11 by the focus distance v₁ and the position separated from the lens 12 toward the image sensor 11 by the focus distance v₂ (i.e., the depth v_{d}(x, y) indicates the smaller of the two values acquired according to Equation (3) given earlier).

Thus, when the focus distance v₁ is greater than the focus distance v₂, and when the absolute value of the first blur circle radius (x, y, v₁) is greater than the absolute value of the second blur circle radius (x, y, v₂); the second calculator 26 calculates the depth v_{d}(x, y) according to Equation (5) given below. In this example, Equation (5) corresponds to “Equation (1)” mentioned in claims.

$${v}_{d} ( x , y ) = \frac{a + b ( x , y , {v}_{1} )}{a} {v}_{1} \qquad ( 5 )$$

Meanwhile, when the focus distance v₁ is greater than the focus distance v₂, and when the absolute value of the first blur circle radius (x, y, v₁) is smaller than the absolute value of the second blur circle radius (x, y, v₂); the second calculator 26 calculates the depth v_{d}(x, y) that represents a value positioned toward the image sensor 11 with respect to the midpoint mentioned above. As can be understood from FIG. 8, when the focus distance v₁ is greater than the focus distance v₂, and when the absolute value of the first blur circle radius (x, y, v₁) is smaller than the absolute value of the second blur circle radius (x, y, v₂); the depth v_{d}(x, y) corresponding to the first blur circle radius (x, y, v₁) represents a value positioned toward the image sensor 11 with respect to the midpoint mentioned above (i.e., the depth v_{d}(x, y) indicates the greater of the two values acquired according to Equation (3) given earlier).

Thus, when the focus distance v₁ is greater than the focus distance v₂, and when the absolute value of the first blur circle radius (x, y, v₁) is smaller than the absolute value of the second blur circle radius (x, y, v₂); the second calculator 26 calculates the depth v_{d}(x, y) according to Equation (6) given below. In this example, Equation (6) corresponds to “Equation (2)” mentioned in claims. In this way, for each pixel I(x, y, v₁) included in the first captured image, the second calculator 26 can calculate the depth v_{d}(x, y) using the first blur circle radius (x, y, v₁) and the second blur circle radius (x, y, v₂).

$${v}_{d} ( x , y ) = \frac{a - b ( x , y , {v}_{1} )}{a} {v}_{1} \qquad ( 6 )$$

However, the first blur circle radius (x, y, v₁) estimated (calculated) in the manner described above may include errors. Hence, for example, the second calculator 26 solves the optimization problem given below in Equation (7) and reduces the effect of errors.

$${v}_{d} = arg {min}_{{v}_{d}} {\sum }_{x , y} \{ {{λ}_{1} ( b ( x , y , {v}_{1} ) - \frac{a}{2 {v}_{d} ( x , y )} \vert {v}_{1} - {v}_{d} ( x , y ) \vert )}^{2} + {λ}_{2} {‖ ∇ {v}_{d} ( x , y ) ‖}^{2} \} \qquad ( 7 )$$

In Equation 7, v_{d} represents the set of a plurality of depths corresponding on a one-to-one basis to a plurality of pixels included in a first captured image, and

$$arg {min}_{b} E$$

represents an operation for searching for “v_{d}” that minimizes “E”.

In Equation 7, ∥∇v_{d}(x, y,)∥² represents a term for evaluating the smoothness of the depth v_{d}(x, y) corresponding to neighboring pixels, and is used to deal with the noise in the image. Meanwhile, in Equation 7, although the squared norm (L2) is used, that is not the only possible case. Alternatively, for example, it is also possible to use the L1 norm. Moreover, the solution of the optimization problem can be acquired by implementing the steepest descent method or the conjugate gradient method. Furthermore, as the initial value of this optimization problem, the calculation result of the depth v_{d}(x, y) can be used.

After calculating the depth using the first blur circle radius, the second calculator 26 can calculate the distance between the lens 12 and the object. However, that is not the only possible case. Alternatively, the second calculator 26 can calculate the distance between the lens 12 and the object by directly using the first blur circle radius. In essence, the second calculator 26 calculates the distance between the optical system used in imaging (in this example, the lens 12) and the object using the first blur circle radius.

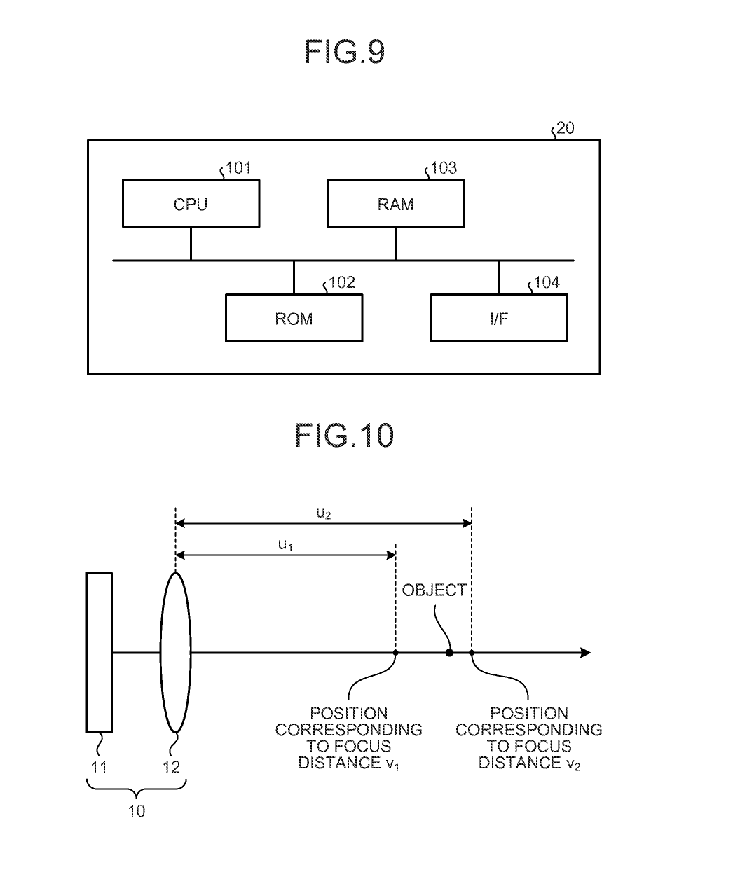

FIG. 9 is a diagram illustrating an exemplary hardware configuration of the image processing device 20. As illustrated in FIG. 9, the image processing device 20 includes a central processing unit (CPU) 101, a read only memory (ROM) 102, a random accessing memory (RAM) 103, and an interface (I/F) 104. The CPU 101 comprehensively controls the operations of the image processing device 20. The ROM 102 is a nonvolatile memory used to store a variety of data such as computer programs. The RAM 103 is a volatile memory serving as the work area for the CPU 101 to perform various operations. The I/F 104 is an interface for establishing connection with an external device such as the imaging device 10.

Herein, the functions of the constituent elements of the image processing device 20 (i.e., the functions of the first acquirer 21, the second acquirer 22, the third acquirer 23, the first calculator 24, the third calculator 25, and the second calculator 26) are implemented when the CPU 101 executes computer programs stored in the ROM 102. However, that is not the only possible case. Alternatively, for example, at least some of the functions of the constituent elements of the image processing device 20 can be implemented using dedicated hardware circuitry (for example, a semiconductor integrated circuit).

Meanwhile, as a comparison example, consider a conventional configuration in which the depth is estimated using the first captured image and the second captured image. For example, as illustrated in FIG. 10, when the position of the object is closer to the position corresponding to the focus distance v₂ (i.e., the position separated by the predetermined distance u₂ from the lens 12 on the opposite side of the image sensor 11) than the position corresponding to the focus distance v₁ (i.e., the position separated by the predetermined distance u₁ from the lens 12 on the opposite side of the image sensor 11), each of a plurality of pixels constituting the object captured in the second captured image has the corresponding second blur circle radius to be smaller than the first blur circle radius corresponding to each of a plurality of pixels constituting the object captured in the first captured image (i.e., blurring of the object is less in the second captured image but increases in the first blurring image). In the comparison example, according to the size of blurring (the relative blurring) from the second captured image to the first captured image, the depth of the object can be uniquely determined (this technology is identical to the known depth-from-defocus method).

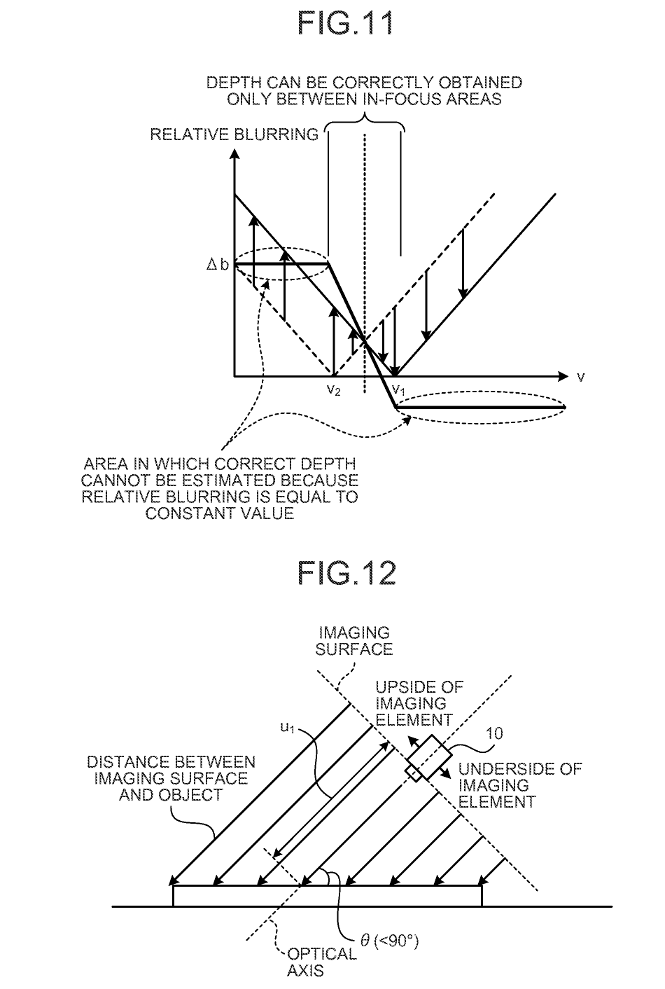

In the comparison example, as illustrated in FIG. 11, since the focus distance v₁ and the focus distance v₂ have different relative blurring, it is possible to correctly estimate the depth. However, in the region other than in a region between the focus distance v₁ and the focus distance v₂, the relative blurring becomes equal to a constant value. Hence, the depth cannot be estimated in a correct manner.

In contrast, in the first embodiment, as described above, the all-in-focus image and the first captured image are used to calculate the first blur circle radius of each of a plurality of pixels included in the first captured image. Hence, regardless of the region in which the object is present, it is possible to calculate the pixel-by-pixel first blur circle radius. Then, as a result of estimating the depths using the first blur circle radii as described above, an advantageous effect can be achieved in the fact that depth estimation becomes possible regardless of the region in which the object is present (i.e., depth estimation becomes possible in all regions).

### Second Embodiment

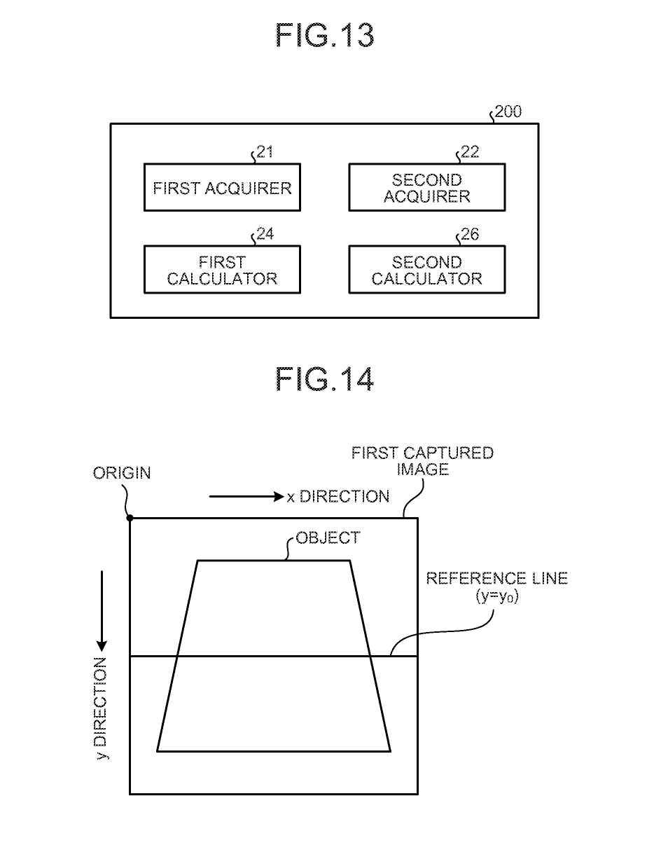

Given below is the explanation of a second embodiment. In the second embodiment, imaging is performed under the premise that the object is a planar object such as a paper sheet and that the optical axis of the imaging device 10 (i.e., the imaging direction) and the plane of the object form an angle smaller than 90°. More particularly, as illustrated in FIG. 12, the imaging device 10 performs imaging under the premise that the optical axis and the plane of the object form an angle smaller than 90° and that the underside of the image sensor 11 is closer to the object as compared to the upside thereof. The detailed explanation is given below. Meanwhile, regarding the common portion with the first embodiment, the redundant explanation is not repeated.

FIG. 13 is a diagram illustrating an image processing device 200 according to the second embodiment. As illustrated in FIG. 13, the image processing device 200 includes the first acquirer 21, the second acquirer 22, the first calculator 24, and the second calculator 26. Herein, the first acquirer 21, the second acquirer 22, and the first calculator 24 have identical functions to the functions explained in the first embodiment. However, the second acquirer 22 acquires such a first captured image which is taken in a state in which the focus distance is set to the first value (v₁) and in which the optical axis of the imaging device 10 and the plane of the object form an angle smaller than 90°. More particularly, the second acquirer 22 acquires such a first captured image which is taken in a state in which the optical axis of the imaging device 10 and the plane of the object form an angle smaller than 90° and in which the underside of the image sensor 11 is closer to the object as compared to the upside thereof.

The second calculator 26 calculates the depth on the basis of the positional relationship between the pixel and a reference line acquired by joining the pixels, where each of the pixels corresponds to the first blur circle radius equal to the value indicating that the group of light beams has converged on the image sensor 11. Although the value is ideally equal to zero, that is not the only possible case; and the value can be equal to or smaller than 0.1 pixels. In the second embodiment, of the pixels I included in the first captured image, the second calculator 26 selects the pixels having the first blur circle radii equal to the value indicating that the group of light beams has converged on the image sensor; and identifies the reference line acquired by joining the selected pixels. FIG. 14 is a schematic diagram illustrating an exemplary reference line. As described earlier, in this example too, the top left coordinate of the first captured image are treated as the origin; the positions in the vertical direction are treated as the y-coordinates; and the positions in the horizontal direction are treated as the x-coordinates. In the example illustrated in FIG. 14, y₀ represents the y-coordinate of the reference line.

For example, in the object captured in the first captured image, regarding the pixels constituting the area separated from the surface parallel to the image sensor 11 (in the following explanation, sometimes referred to as an imaging surface) by the distance u₁ corresponding to the focus distance v₁, the respective first blur circle radii are equal to the value indicating that the group of light beams has converged (i.e., the value indicating that there is no blurring, and the value is ideally equal to zero). On the other hand, in the object captured in the first captured image, regarding the pixels constituting the area separated from the imaging surface by a distance greater than the distance u₁ corresponding to the focus distance v₁ (i.e., herein, the pixels having values of the y-coordinate smaller than the reference line), the respective first blur circle radii are not equal to the value indicating that the group of light beams has converged, and the distance between the lens 12 and the point at which the group of light beams coming from that area converges after passing through the lens 12 becomes smaller than the focus distance v₁ (according to 1/f=1/v+1/u). Moreover, in the object captured in the first captured image, regarding the pixels constituting the area separated from the imaging surface by a distance smaller than the distance u₁ corresponding to the focus distance v₁ (i.e., herein, the pixels having values of the y-coordinate greater than the reference line), the respective first blur circle radius are not equal to the value indicating that the group of light beams has converged, and the distance between the lens 12 and the point at which the group of light beams coming from that area converges after passing through the lens 12 becomes greater than the focus distance v₁.

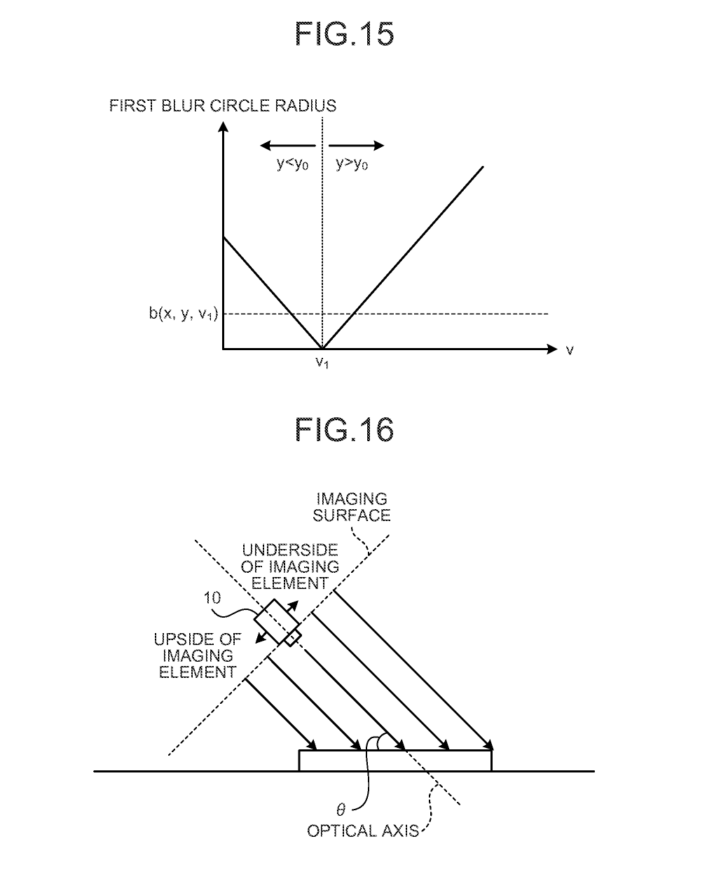

FIG. 15 is a schematic diagram illustrating the relationship between the distance v from the lens 12 in the direction toward the image sensor 11 and the absolute value of the first blur circle radius b(x, y, v₁). As can be understood from FIG. 15, for the pixels having the same absolute value of the first blur circle radius b(x, y, v₁), regarding the pixel having a value of the y-coordinate smaller than the reference line, the distance v (can also be considered as the depth v_{d}(x, y)) corresponding to the first blur circle radius b(x, y, v₁) is smaller than the focus distance v₁. In contrast, regarding the pixel having a value of the y-coordinate greater than the reference line, the distance v corresponding to the first blur circle radius b(x, y, v₁) is greater than the focus distance v₁.

Thus, in the second embodiment, from among a plurality of pixels I(x, y, v₁) included in the first captured image, as the depth v_{d}(x, y) corresponding to a pixel I(x, y, v₁) having a value of the y-coordinate smaller than the reference line, the second calculator 26 calculates the depth v_{d}(x, y) smaller than the focus distance v₁ (the first value). On the other hand, as the depth v_{d}(x, y) corresponding to a pixel I(x, y, v₁) having a value of the y-coordinate greater than the reference line, the second calculator 26 calculates the depth v_{d}(x, y) greater than the focus distance v₁ (the first value). More particularly, as the depth v_{d}(x, y) corresponding to a pixel I(x, y, v₁) having a value of the y-coordinate smaller than the reference line, the second calculator 26 calculates the depth v_{d}(x, y) according to Equation (5) given earlier. In this example, Equation (5) corresponds to “Equation (1)” mentioned in claims. Moreover, as the depth v_{d}(x, y) corresponding to a pixel I(x, y, v₁) having a value of the y-coordinate greater than the reference line, the second calculator 26 calculates the depth v_{d}(x, y) according to Equation (6) given earlier. In this example, Equation (6) corresponds to “Equation (2)” mentioned in claims. Other than that, the details are identical to the first embodiment.

Meanwhile, for example, as illustrated in FIG. 16, even if the optical axis of the imaging device 10 (i.e., the imaging direction) and the surface of the object form an angle smaller than 90°, if the upside of the image sensor 11 is closer to the object as compared to the underside side thereof, the relationship described above gets reversed. For example, assume that a gyro sensor detects that the imaging device 10 has the orientation in which the upside of the image sensor 11 is closer to the object as compared to the underside thereof. In that case, as the depth v_{d}(x, y) corresponding to a pixel I(x, y, v₁) having a value of the y-coordinate smaller than the reference line, the second calculator 26 can calculate the depth v_{d}(x, y) according to Equation (6) contrary to the earlier explanation. Moreover, as the depth v_{d}(x, y) corresponding to a pixel I(x, y, v₁) having a value of the y-coordinate greater than the reference line, the second calculator 26 can calculate the depth v_{d}(x, y) according to Equation (5) contrary to the earlier explanation.

### Third Embodiment

Given below is the explanation of a third embodiment. In the third embodiment, without using the first blur circle radii equal to or smaller than a threshold, the second calculator 26 calculates the depths such that the depths corresponding to neighboring pixels become smoothly continuous. The detailed explanation is given below. Meanwhile, regarding the common portion with the first and second embodiments, the redundant explanation is not repeated.

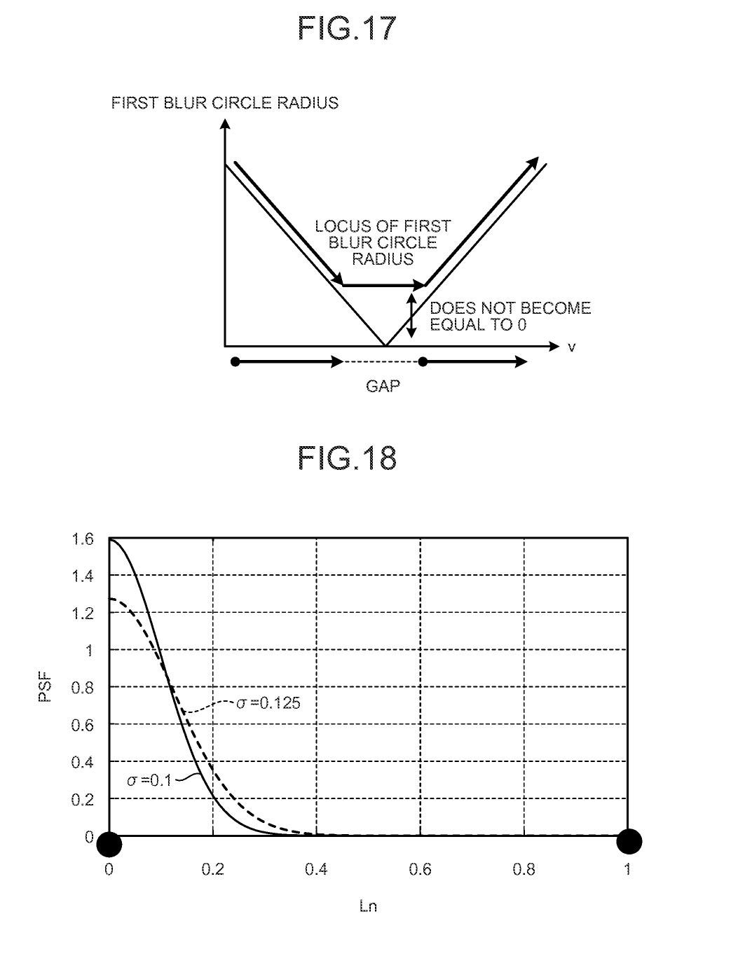

As illustrated in FIG. 17, there is a characteristic feature that the estimated value of the first blur circle radii b(x, y, v₁) is rarely equal to zero. That is because of the following reason. As illustrated in FIG. 18, during the estimation of the first blur circle radii b(x, y, v₁) according to Equation (1) given earlier, the first blur circle radii b(x, y, v₁) are lowered; and, as the weight σ corresponding to the first blur circle radii b(x, y, v₁) goes on decreasing (for example, in the vicinity of σ=0.1), there is no difference in the results of convolution operations. Hence, in the vicinity of zero, the reliability of the first blur circle radii b(x, y, v₁) undergoes a decline. Meanwhile, in FIG. 18, the vertical axis represents values of the point spread function (PSF), and the horizontal axis represents a distance Ln from an arbitrary single pixel.

In that regard, without using the first blur circle radii equal to or smaller than a threshold (for example, a threshold equal to zero, or can be a value such as 0.1 pixels according to the design condition), the second calculator 26 calculates the depths such that the depths corresponding to neighboring pixels become smoothly continuous. More particularly, the second calculator 26 solves the optimization problem given below in Equation (8), and calculates the depth v_{d}(x, y) for each pixel I(x, y, v₁) included in the first captured image.

$${v}_{d} = arg {min}_{{v}_{d}} {\sum }_{x , y} \{ {λ}_{1} p ( b ( x , y , {v}_{1} ) ) {( b ( x , y , {v}_{1} ) - \frac{a}{2 {v}_{d} ( x , y )} \vert {v}_{1} - {v}_{d} ( x , y ) \vert )}^{2} + {λ}_{2} {‖ ∇ {v}_{d} ( x , y ) ‖}^{2} \} \\ p ( b ( x , y , {v}_{1} ) ) = \frac{1}{1 + exp ( - α ( b ( x , y , {v}_{1} ) ) - β )} \qquad ( 8 )$$

In Equation (8), v_{d} represents the set of a plurality of depths corresponding on a one-to-one basis to a plurality of pixels included in a first captured image, and

$$arg {min}_{b} E$$

represents an operation for searching for “v_{d}” that minimizes “E”.

In Equation 8, ρ(b(x, y, v₁)) represents a robust function, and α>0 and β represent the parameters determining the format of the robust function. In this example, β is equivalent to the threshold mentioned above. Thus, when the first blur circle radius (x, y, v₁) is equal to or smaller than β, the robust function becomes equal to zero. In this example, although a sigmoid robust function is used, that is not the only possible case. Moreover, the solution of the optimization problem can be acquired by implementing the steepest descent method or the conjugate gradient method.

### MODIFICATION EXAMPLES

Given below is the explanation of modification examples.

### (1) First Modification Example

An all-in-focus image can be generated by implementing an arbitrary method. For example, as disclosed in JP-A 2013-110700 (KOKAI), an all-in-focus image can be generated by processing images taken by varying the focal point (focus) during exposure. Alternatively, for example, images taken in a continuous manner while varying the focus distance are processed to generate a stored image, and blur removal is performed with respect to the stored image so as to generate an all-in-focus image. According to this method, all-in-focus images can be generated while keeping the aperture fixed. Hence, for example, even in an imaging device 10 such as an image sensor which is installed in a smartphone and in which the aperture cannot be varied, it is possible to generate all-in-focus images.

### (2) Second Modification Example

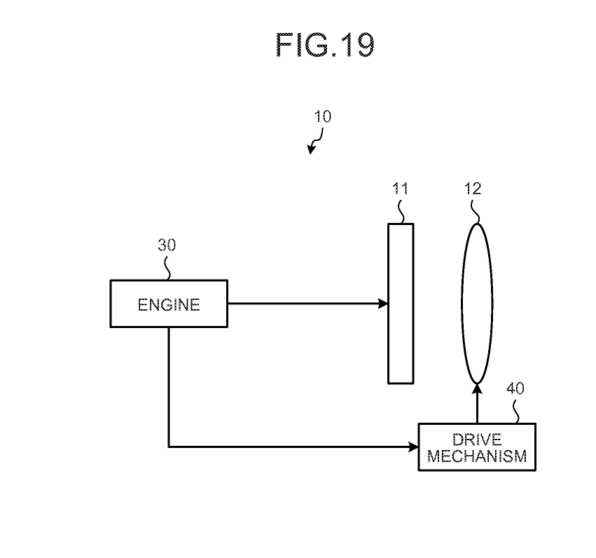

For example, the image processing device 20 can be installed in the imaging device 10. FIG. 19 is a diagram illustrating an exemplary hardware configuration of the imaging device 10 according to the second modification example. As illustrated in FIG. 19, the imaging device 10 includes an engine 30 and a drive mechanism 40 in addition to including the image sensor 11 and the lens 12. For example, when the focus distance is to be varied, the drive mechanism 40 moves the lens under the control of the engine 30. The drive mechanism 40 can have any one of various known configurations. The engine 30 comprehensively controls the operations of the imaging device 10. In this example, the functions of the constituent elements of the image processing device 20 (i.e., the functions of the first acquirer 21, the second acquirer 22, the third acquirer 23, the first calculator 24, the third calculator 25, and the second calculator 26) are implemented in the engine 30.

### (3) Third Modification Example

In the embodiments described above, the all-in-focus images, the first captured images, and the second captured images are generated using a single imaging device 10. However, that is not the only possible case. Alternatively, for example, the images can be generated using two or more imaging devices 10. However, if the two or more imaging devices 10 are installed at different positions, then the all-in-focus images, the first captured images, and the second captured images need to be generated upon performing correction by taking into account the position differences. Regarding the correction of position differences, it is possible to implement various known technologies.

Meanwhile, it is also possible to arbitrarily combine the embodiments and the modification examples described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image processing device comprising:
a processing circuit configured to:
acquire an all-in-focus image and a first captured image taken at a first focus distance;
calculate, with respect to a pixel included in the first captured image, a first blur circle radius using the all-in-focus image and the first captured image; and
calculate a first depth representing a distance to an object included in at least one of the first captured image and the all-in-focus image using the first blur circle radius.

2. The device according to claim 1 wherein the processing circuit calculates a second depth representing a distance between an optical system used in imaging and a point at which a group of light beams coming from the object converges after passing through the optical system using the first blur circle radius and calculates the first depth using the second depth.

3. The device according to claim 1, wherein the processing circuit calculates the first blur circle radius by estimating extent of blurring to which the all-in-focus image needs to be blurred to approximate the first captured image.

4. The device according to claim 1, wherein the processing circuit calculates the first blur circle radius such that an error between the first captured image and an image acquired by applying a Gaussian filter to the all-in-focus image with use of a weight corresponding to the first blur circle radius is minimized.

5. The device according to claim 1, wherein the processing circuit acquires a second captured image taken at a second focus distance, calculates a second blur circle radius with respect to a pixel included in the second image using the all-in-focus image and the second captured image, and calculates the first depth using the first blur circle radius and the second blur circle radius.

6. The device according to claim 5, wherein the first captured image and the all-in-focus image are taken by an imaging device including an optical system and an image sensor to capture light beams passing through the optical system.

7. The device according to claim 6, wherein
when the first focus distance is greater than the second focus distance and the first blur circle radius is greater than the second blur circle radius, the processing circuit calculates the first depth that represents a value positioned toward the optical system with respect to midpoint between a position separated from the optical system toward the image sensor by the first focus distance and a position separated from the optical system toward the image sensor by the second focus distance.

8. The device according to claim 6, wherein
when the first focus distance is greater than the second focus distance and the first blur circle radius is smaller than the second blur circle radius, the processing circuit calculates a second depth that represents a value positioned toward the image sensor with respect to midpoint between a position separated from the optical system toward the image sensor by the first focus distance and a position separated from the optical system toward the image sensor by the second focus distance.

9. The device according to claim 6, wherein
when the first focus distance is greater than the second focus distance and the first blur circle radius is greater than the second blur circle radius, the processing circuit calculates the second depth according to Equation (1) given below, and
when the first focus distance is greater than the second focus distance and when the first blur circle radius is smaller than the second blur circle radius, the processing circuit calculates the second depth according to Equation (2) given below,
$${v}_{d} ( x , y ) = \frac{a + b ( x , y , {v}_{1} )}{a} {v}_{1} \qquad ( 1 )$$
where v_{d}(x, y) represents the second depth corresponding to a pixel positioned at coordinates (x, y) from among a plurality of pixels included in the first captured image; b(x, y, v₁) represents the first blur circle radius corresponding to a pixel positioned at coordinates (x, y); a represents an aperture acquired by dividing focal length of a lens, which functions as the optical system, by f-number; and v₁ represents the first focus distance, and
$${v}_{d} ( x , y ) = \frac{a - b ( x , y , {v}_{1} )}{a} {v}_{1} \qquad ( 2 )$$
where v_{d}(x, y) represents the second depth corresponding to a pixel positioned at coordinates (x, y) from among a plurality of pixels included in the first captured image; b(x, y, v₁) represents the first blur circle radius corresponding to a pixel positioned at coordinates (x, y); a represents an aperture acquired by dividing focal length of a lens, which functions as the optical system, by f-number; and v₁ represents the first focus distance.

10. The device according to claim 6, wherein the processing circuit calculates the second blur circle radius by estimating extent of blurring to which the all-in-focus image needs to be blurred to approximate the second captured image.

11. The device according to claim 6, wherein processing circuit calculates the second blur circle radius such that an error between the second captured image and an image formed by applying a Gaussian filter to the all-in-focus image with use of a weight corresponding to the second blur circle radius is minimized.

12. The device according to claim 1, wherein
the processing circuit acquires the first captured image taken in a state in which an optical axis of an imaging device and a surface of the object form an angle smaller than 90°, and calculates the first depth on the basis of positional relationship between the pixel and a reference line acquired by joining the pixels, each corresponding to the first blur circle radius indicating that a group of light beams has converged on an image sensor included in the imaging device.

13. The device according to claim 12, wherein
the processing circuit acquires the first captured image that is acquired in a state in which an underside of the image sensor is closer to the object as compared to an upside of the image sensor,
in the first captured image, top left coordinate is treated as an origin, a position in vertical direction is treated as y-coordinate, and a position in horizontal direction is treated as x-coordinate,
the processing circuit calculates, as a second depth corresponding to the pixel having a value of the y-coordinate smaller than the reference line, the second depth that represents a value smaller than the first focus distance, and
the processing circuit calculates, as the second depth corresponding to the pixel having a value of the y-coordinate greater than the reference line, the second depth that represents a value greater than the first focus distance.

14. The device according to claim 13, wherein
the processing circuit calculates the second depth corresponding to the pixel having the value of the y-coordinate smaller than the reference line according to Equation (1) given below, and calculates the second depth corresponding to the pixel having the value of the y-coordinate greater than the reference line according to Equation (2) given below,
$${v}_{d} ( x , y ) = \frac{a + b ( x , y , {v}_{1} )}{a} {v}_{1} \qquad ( 1 )$$
where v_{d}(x, y) represents the second depth corresponding to a pixel positioned at coordinates (x, y) from among a plurality of pixels included in the first captured image; b(x, y, v₁) represents the first blur circle radius corresponding to a pixel positioned at coordinates (x, y); a represents an aperture acquired by dividing focal length of a lens, which functions as the optical system, by f-number; and v₁ represents the first focus distance, and
$${v}_{d} ( x , y ) = \frac{a - b ( x , y , {v}_{1} )}{a} {v}_{1} \qquad ( 2 )$$
where v_{d}(x, y) represents the second depth corresponding to a pixel positioned at coordinates (x, y) from among a plurality of pixels included in the first captured image; b(x, y, v₁) represents the first blur circle radius corresponding to a pixel positioned at coordinates (x, y); a represents an aperture acquired by dividing focal length of a lens, which functions as the optical system, by f-number; and v₁ represents the first focus distance.

15. The device according to claim 1, wherein the processing circuit calculates, without using the first blur circle radius equal to or smaller than a threshold, the first depths such that the first depths corresponding to neighboring pixels become smoothly continuous.

16. An image processing device comprising:
a processor;
a memory that stores processor-executable instructions that, when executed by the processor, cause the processor to:
acquire an all-in-focus image and a first captured image taken at a first focus distance;
calculate, with respect to a pixel included in the first captured image, a first blur circle radius using the all-in-focus image and the first captured image; and
calculate a first depth representing a distance to an object included in at least one of the first captured image and the all-in-focus image using the first blur circle radius.

17. An imaging device comprising:
the device according to claim 1; and
an image sensor.

18. An image processing method comprising:
acquiring an all-in-focus image;
acquiring a first captured image taken at a first focus distance;
calculating, with respect to a pixel included in the first captured image, a first blur circle radius using the all-in-focus image and the first captured image; and
calculating a first depth representing a distance to an object included in at least one of the first captured image and the all-in-focus image using the first blur circle radius.
